(19) United States
(12) Patent Application Publication
(10) Pub. No.: US 2024/0352593 A1
(43) Pub. Date: Oct. 24, 2024

(54) CELL FRAME FOR AN ELECTROLYTIC CELL

(71) Applicant: H2i GreenHydrogen GmbH, Wallern an der Trattnach (AT)

(72) Inventors: Dietmar NEUBACHER, Graz (AT); Bernd CERMENEK, Graz (AT)

(73) Assignee: H2i GreenHydrogen GmbH, Wallern an der Trattnach (AT)

(21) Appl. No.: 18/683,005

(22) PCT Filed: Aug. 11, 2022
(86) PCT No.: PCT/AT2022/060281

§ 371 Date: Feb. 12, 2024

(30) Foreign Application Priority Data
Aug. 13, 2021 (AT) A50662/2021

(51) Int. Cl. C25B 1/02; C25B 9/19; C25B 9/60; C25B 9/70

(52) U.S. Cl. CPC C25B 1/02; C25B 9/19; C25B 9/60; C25B 9/70

(57) ABSTRACT

An electrolytic cell for producing gaseous hydrogen is disclosed and comprises the following arranged along a cell axis: at least one anion exchange membrane and at least a first cell frame and a second cell frame. The cell frames delimit respective inner regions, and thus two half-cells are formed. The cell frames are mutually spaced in the direction of the cell axis, the first cell frame being located on a first flat side of the anion exchange membrane and the second cell frame being located on an opposite second flat side of the anion exchange membrane. The first and second cell frames comprise at least one outflow channel structure, which is fluidically coupled to the first flow channel and to the inner region, and at least one inflow channel structure, which is fluidically coupled to the second flow channel and to the inner region of the cell frame in question.

### CELL FRAME FOR AN ELECTROLYTIC CELL

The invention relates to an electrolytic cell for producing gaseous hydrogen, the electrolytic cell comprising the following arranged along a cell axis: at least one anion exchange membrane and at least a first cell frame and a second cell frame. The present invention is characterized by a particularly simple configuration of the electrolytic cell which is nevertheless advantageous for the electrolysis process.

EP2898115B1 discloses a cell frame for an electrolysis block, in particular for alkaline water electrolysis, with a front-side discharge channel structure and a rear-side discharge channel structure. The cell frame is made of a material with sealing properties and has sealing beads and corresponding sealing indentations on one opposite side. The cell frame is also provided with product gas discharge structures for separately discharging two product gases through product gas discharge openings and discharge channels, wherein the product gas discharge openings are offset from one another by a predetermined angle in the circumferential direction on the cell frame, in particular by an angle of between 5° and 60°. With regard to the simplicity of the configuration of the cell frames used and in particular with regard to the use of the cell frames in an electrolysis block for carrying out the process of electrolysis, this disclosure shows only a partially satisfactory technical solution.

Furthermore, EP3696298A1 describes a cell frame for an electrolysis or fuel cell block with a plurality of collecting channel openings which are set up for media feed and media discharge through the cell frame. The disclosed cell frame comprises a distribution channel structure which is arranged to supply media from a respective supplying collecting channel opening to an associated half-space adjacent to the receiving opening and to discharge media from this half-space to an associated discharging collecting channel opening. This disclosed embodiment of a cell frame is only partially satisfactory with regard to the simplicity of the design and with regard to the effectiveness of the media supply and media discharge.

The object of the present invention was to overcome the disadvantages of the prior art and to provide an electrolytic cell which is particularly easy to manufacture, while at the same time the physical process of electrolysis should be as efficient as possible.

This object is achieved by an electrolytic cell according to the claims.

The electrolytic cell for producing gaseous hydrogen according to the invention comprises the following arranged along a cell axis: at least one anion exchange membrane and at least a first cell frame and a second cell frame. The cell axis is preferably aligned horizontally. The cell frames each enclose an inner region that is provided to receive an electrolyte and/or a membrane electrode unit. The membrane-electrode unit is formed by the anion exchange membrane and at least one electrode and/or a diffusion layer. It is expedient if the membrane electrode unit is provided with a first electrode on a first flat side of the anion exchange unit and a second electrode on a second flat side of the anion exchange membrane opposite the first flat side, one of the electrodes acting as a cathode in the electrolysis process and the other electrode acting as an anode. The diffusion layer ensures an electrically conductive connection between a flat side of a bipolar plate and an electrode arranged closest to the bipolar plate, wherein electrolyte may diffuse through the diffusion layer at the same time.

The at least one first cell frame and the at least one second cell frame are arranged in such a way that they are spaced apart in the direction of the cell axis with respect to their respective defined frame planes, wherein the first cell frame abuts on a first flat side of the anion exchange membrane directly or indirectly in a liquid-and gas-sealing manner and the second cell frame abuts on an opposite second flat side of the anion exchange membrane directly or indirectly in a liquid-and gas-sealing manner. It should also be noted that an additional flat gasket may be arranged along the cell axis between the first and/or the second cell frame and the anion exchange membrane.

Furthermore, the electrolytic cell comprises at least one first flow channel and at least one second flow channel, which flow channels are each formed by fluidically communicating apertures in the first and second cell frame and in the anion exchange membrane and whose main direction extends parallel or substantially parallel to the cell axis. The at least one first flow channel and the at least one second flow channel are spaced apart in a radial direction with respect to the cell axis and positioned opposite one another with respect to the cell axis.

The at least one first cell frame and the at least one second cell frame each have at least one outflow channel structure, which is fluidically coupled to the first flow channel and to the inner region of the respective cell frame. Furthermore, the at least one first cell frame and the at least one second cell frame each have at least one inflow channel structure, which is fluidically coupled to the second flow channel and to the inner region of the respective cell frame.

The inflow channel structure and/or the outflow channel structure have at least two partial channels extending at an angle to one another, which partial channels open directly into the at least one first flow channel and/or emerge directly from the at least one second flow channel. Each of the partial channels is fluidically coupled to the inner region of the respective cell frame.

The arrangement of the inflow channel structure and the outflow channel structure in conjunction with the partial channels thus creates a favorable flow distribution in the inner region of the electrolytic cell, which prevents the formation of areas with low flow velocity in relation to the average flow velocity in the inner region. This results in a particularly advantageous flow, in particular the most efficient possible flushing of the inner region surrounded by the cell frame, and subsequently a high degree of removal of the product gases or gas bubbles formed in the inner regions of the cell frames. The arrangement of the anion exchange membrane, the at least one first cell frame and the at least one second cell frame as described above results in an inner region surrounded by the respective cell frame being formed on each side of the anion exchange membrane. The respective inner region on each side of the anion exchange membrane thus forms a half-cell of the electrolytic cell, which half-cells are provided for carrying out the electrolysis.

During the electrolysis process, product gases are produced within the respective half-cell at the anion exchange membrane. The disclosed advantageous configuration of the electrolytic cell and the resulting advantageous flow conditions within the respective half-cell favor the detachment of gas bubbles from the anion exchange membrane in the peripheral regions of the respective half-cell. This not only increases the service life of the anion exchange membrane but also improves its effectiveness. A further advantageous effect is the uniform distribution of fluid or electrolyte within the half-cells resulting from the special configuration of the outflow channel structure and the inflow channel structure and the associated improved cooling or, if necessary, improved heating of the anion exchange membrane depending on the operating state of the electrolytic cell.

According to an advantageous further embodiment, it is conceivable that the first and/or second cell frame are provided with an inner limiting edge which defines a limiting section of the inner region, and which inner limiting edge has an upper and/or a lower straight section in the upper region and/or in the lower region with respect to a vertically extending frame plane of the first and/or second cell frame. In the lower straight section, at least one partial channel of the inflow channel structure extends parallel or in alignment with the lower straight section and, furthermore, in the upper straight section, at least one partial channel of the outflow channel structure extends parallel or in alignment with the upper straight section.

It may be useful if the partial channels of the outflow channel structure and/or the partial channels of the inflow channel structure extend in a straight line.

The main advantage of this further embodiment is that the operating medium flowing into the inner region of the electrolytic cell and flowing out of the inner region of the electrolytic cell, or the electrolyte or a two-phase mixture of electrolyte and dissolved gases, is guided into the areas of the edge zones of the inner region. This results in an ideal utilization of the active surface of the anion exchange membrane during the electrolysis process. Furthermore, this results in a homogenized distribution of the operating medium in each inner region of a cell frame or in each half-cell of the electrolytic cell, which also results in a high degree of efficiency of the electrolytic cell. This advantageous configuration also improves the convective heat transfer between the operating medium and the respective cell frame and subsequently between the active surface of the anion exchange membrane and the respective cell frame. This advantageous effect results in increased operational reliability of the electrolytic cell and, in addition, a longer service life. Furthermore, this reduces the requirements for the material properties and the material thicknesses or the thickness extension along the cell axis of the anion exchange membrane, which brings a particular economic advantage with regard to the production of the electrolytic cell.

Another advantageous configuration is one according to which it may be provided that at least one partial channel of the outflow channel structure is fluidically coupled to the inner region of the first and/or second cell frame in relation to the vertically extending frame plane at an uppermost partial section of the inner limiting edge with the inner region.

This measure achieves a particularly favorable flow condition within the respective half-cell of the electrolytic cell, since on the one hand no dome or cupola is formed in the upper area of the respective half-cell in relation to the vertical plane, in which dome a gas bubble accumulation would form during operation of the electrolytic cell. Such an accumulation of gas bubbles leads, among other things, to locally high resistances at the anion exchange membrane and thus to a possibly inadmissible thermal load on the same. On the other hand, this measure also prevents a sink from forming in the lower region of the respective half-cell in relation to the vertical plane. Such a sink would lead to a region with low flow speeds or to a dead space in terms of flow and thus to a prevented exchange of operating medium. An exchange prevented in this way would lead to a thermally inadmissible zone at the anion exchange membrane. In any case, this advantageous configuration of the electrolytic cell increases the degree of efficiency of the electrolysis process within the electrolytic cell. On the other hand, the service life of the anion exchange membrane is increased and safety is also improved, as an ideal flow through the respective half-cell of the electrolytic cell is guaranteed.

Furthermore, it may be provided that the at least one first cell frame and the at least one second cell frame are structurally and geometrically identical and are arranged turned through 180° with respect to a vertical axis extending in the vertically extending frame plane.

This advantageous further embodiment results above all in the economic benefit of the common part principle. In addition to the production-related advantages, the reduced complexity of assembling an electrolytic cell also results in further benefits. This reduces the probability of an incorrect arrangement of the individual plate-shaped elements along the cell axis. Furthermore, the flow-guiding measures of the electrolytic cell for supplying the half-cells with operating medium are fully integrated into the respective cell frames. Since the thickness extensions of the cell frames make up the main part of the longitudinal extension of an electrolysis device consisting of several stacked electrolytic cells along the cell axis, this results in further economic advantages, especially with regard to the total manufacturing costs of such an electrolysis device.

Furthermore, it may be expedient if the at least one first cell frame and the at least one second cell frame each have an outflow channel structure and a respective inflow channel structure and that the respective outflow channel structure and the respective inflow channel structure of the respective cell frame are formed by respective groove-like indentations or embossings in only one of the two flat sides of the respective cell frame.

It is advantageous that a flat side of a cell frame does not have any groove-like indentations or embossings for a channel structure and therefore a plate-shaped element adjoining this flat side along the cell axis, such as a flat gasket, has an increased service life. This results from the fact that each embossing or aperture in a cell frame causes a notch effect on the neighboring plate-shaped element due to a pressure-tight arrangement with the respective neighboring plate-shaped element. Particularly when the electrolytic cell is operated with pulsating temperature and/or pressure loads, the plate-shaped elements are subject to relative sliding offsets or sliding movements in relation to each other, wherein a notch effect causes an increased load on the respective plate-shaped element. With the specified extension of the electrolytic cell, such a load is now reduced by reducing or avoiding groove-like indentations or embossings on a flat side of a cell frame. In addition to increased safety of the entire electrolytic cell, this also results in economic advantages with regard to the materials used for the materials connected to the respective cell frames and thus with regard to the time intervals between maintenance cycles.

In addition, it may be provided that the at least one first cell frame and the at least one second cell frame are arranged opposite the anion exchange membrane in such a way that the respective flat side of the cell frames without groove-like indentations or embossings is associated closest to the anion exchange membrane.

In this conceivable configuration, it is particularly advantageous that the contacted clamping surface or the contact surface between the cell frame and a plate-shaped element closest to the flat side of the respective cell frame, in particular an anion exchange membrane or a flat gasket, is maximized. This means that the seal between the at least one cell frame and the nearest plate-shaped element along the cell axis is particularly reliable and, furthermore, the stability of the electrolytic cell is increased by the homogenized and surface-maximized contact between the plate-shaped elements. As a result, it is thus possible to arrange a plate-shaped element that is closest in the direction of the cell axis with a smaller thickness extension along the cell axis due to the minimized notch effect caused by the absence of groove-like indentations or embossings on a flat side of the respective cell frame than in comparison with an embodiment with groove-like indentations or embossings on the contacting flat side. This increases the efficiency of the electrolytic cell, as the ohmic resistance is reduced due to the lower component thicknesses or the thickness extension along the cell axis of the plate-shaped elements and losses are reduced.

Furthermore, it may be expedient for the anion exchange membrane to be connected in a liquid-and gas-tight manner to the nearest associated flat side of the at least one first cell frame and/or the at least one second cell frame by bonding, welding and/or pressing. Essentially, the connection between at least one cell frame and the anion exchange membrane is therefore technically tight.

In addition to the effect of a gas-tight connection of the plate-shaped elements, it is advantageous that the complexity of assembling the electrolytic cell is reduced and thus possible sources of error due to incorrect assembly are minimized. On the other hand, this configuration eliminates the need for a joining or sealing plane to be sealed or an additional flat gasket between a cell frame and the anion exchange membrane, which improves the overall sealing of the electrolytic cell. Furthermore, the resulting improved stabilization of the anion exchange membrane is an advantageous effect that subsequently increases the service life of the electrolytic cell. Possible sources of error when assembling an electrolysis device consisting of several electrolytic cells stacked along the cell axis are also reduced, as an assembly consisting of cell frame and anion exchange membrane has already been formed. This simplifies the assembly of electrolytic cells arranged along the cell axis, as the number of individual components in the assembly process is reduced.

Another advantageous configuration is one according to which it may be provided that the inner limiting edge of the first and/or second cell frame has a circular arc shape or an elliptical shape in sections and, in the case of an elliptical shape, its main elliptical axis or its secondary elliptical axis is orientated parallel or essentially parallel to the vertical axis.

This results in a directional flushing around the edges of the inner region of the cell frame or the half-cells of the electrolytic cell. In combination with the disclosed positioning of the inflow channel structure and the outflow channel structure on the respective cell frame, this induces an S-shaped flow pattern or flow turbulence in the inner region of the respective cell frame or in the half-cells of the electrolytic cell. This means that the flow pattern within the respective half-cell is configured in such a way that the gas bubble separation from the anion exchange membrane is favored. This in turn has a positive effect on the service life of the anion exchange membrane and on its service life and effectiveness. At the same time, the resulting round or rounded basic shape of the inner region counteracts the possible formation of flow areas with low flow speeds.

In particular, it may be expedient that the cross-section of the at least one first flow channel and/or the at least one second flow channel of the electrolytic cell is configured to be increasingly tapering or increasingly enlarging along the cell axis.

This configuration creates the advantageous effect of an accelerated or decelerated flow in the flow channels of the electrolytic cell or in the flow channels of a plurality of electrolytic cells arranged along the cell axis, depending on the requirements. Depending on the situation of supplying an electrolytic cell with an operating medium by means of the flow channels and depending on the desired optimum operating mode of the electrolytic cell, this measure has a positive influence on the flow state of the flow from the inflow channel structure into the inner region of the respective cell frame, i.e. into the respective half-cell. Furthermore, this measure in the area of the first flow channel has an advantageous effect on the flow state of the operating medium, in particular a two-phase flow consisting of operating medium and dissolved gases in the outflow channel structure. Another technical advantage here is the effective discharge of the gas bubbles from the anion exchange membrane.

In addition, it may be provided that the at least one first flow channel is configured to be increasingly enlarging in a first flow channel direction along the cell axis and that the at least one second flow channel is configured to be increasingly tapering in a second flow channel direction opposite to the first flow channel direction.

This measure has a particularly favorable effect on the flow condition in the inner region of a respective cell frame if several electrolytic cells are arranged or stacked at a distance along the cell axis with, for example, at least one bipolar plate and any flat gaskets. Since the volume flow of an operating medium, which is supplied to the inner region of the cell frame or to a respective half-cell via the at least one second flow channel, decreases in the at least one flow channel over its longitudinal extension along the second flow channel direction, the increasing tapering along the second flow channel direction keeps the flow speed of the medium within a defined range and thus ensures an ideal supply to the respective inner regions of the electrolytic cells arranged in a row or stacked along the cell axis.

In the same way, the at least one first flow channel, which is configured to be increasing along the first flow channel direction, ensures the continuous discharge of the medium from the respective inner region of the electrolytic cells arranged in a row. In addition to this effect, the at least one first flow channel, which is configured to be increasing along the first flow channel direction, has a positive effect on the gas bubble transport within the two-phase mixture to be discharged from the inner region of the respective half-cells of the electrolytic cells. The specified embodiment therefore has a direct effect on increasing the overall degree of efficiency of electrolytic cells. At the same time, the constant maintenance of the supply to each electrolytic cell in turn improves the service life and safety of the same, as the volume flow of operating medium supplied and discharged as intended ensures sufficient cooling or, if necessary, heating and intensive gas bubble detachment from the anion exchange membrane in the respective electrolytic cell.

In particular, it may be advantageous that the flow cross-section of at least one partial channel of the outflow channel structure and/or the inflow channel structure is provided with a widening starting from the respective flow channel in the direction of the inner region, which widening is configured in particular to be trumpet-shaped.

This further embodiment is particularly advantageous, as an accelerated flow is induced when flowing from the inner region into the respective partial channel of the outflow channel structure, which favors the entrainment of dissolved gas bubbles of a product gas in the two-phase mixture of fluid or operating medium and product gas from the respective half-cell or from the inner region of the respective cell frame of the electrolytic cell.

Furthermore, it may be expedient that the at least two partial channels of the outflow channel structure and/or the at least two partial channels of the inflow channel structure extend at an angle in the range between 27.5° and 135°, in particular at an angle of 90°, to one another and that at least one third partial channel is arranged between the at least two partial channels of the outflow channel structure and/or at least one third partial channel is arranged between the at least two partial channels of the inflow channel structure.

As a result, it is subsequently possible for the cell frames to be smaller in terms of their thickness along the cell axis, i.e. in relation to the thickness of a cell frame, than in an embodiment with two partial channels per inflow and/or outflow channel structure, since the complete channel cross-section of the respective partial channels of the further embodiment described is also largely the same or similar in size to an embodiment with two partial channels per inflow or outflow channel structure. In addition to a reduced axial extension of the electrolytic cell, the reduced thickness of the cell frame results in the significant advantage of reduced thermal expansion of the cell frame under thermal load and thus improved sealing and increased safety of the electrolytic cell. In addition, the advantageous extension described increases the power density per unit length along the cell axis of an electrolysis device consisting of several electrolytic cells.

According to a further embodiment, it is possible that along the inner limiting edge of the at least one first cell frame and/or the at least one second cell frame at least one protuberance enclosing the outflow channel structure and/or the inflow channel structure and circumferentially closed is formed opposite the base surface of the respective cell frame, which at least one protuberance is provided as a sealing element. In particular, it is advantageous if at least one protuberance or the sealing element is integrally connected to the respective cell frame, i.e. is configured as an integral component of the respective cell frame.

As the sealing element is thus positioned as close as possible to the inner region of the respective cell frame and enclosing the inflow and outflow channel structure, this results in the advantage of a particularly effective seal in the area between a cell frame and a further plate-shaped element adjacent to the flat side of the cell frame, such as a flat gasket or a bipolar plate. This effectively prevents the diffusion of product gases from the inner region of a cell frame or from a respective half-cell.

Furthermore, it may be advantageous if the at least one circumferentially closed protuberance is formed at least on one flat side of the at least one first cell frame and/or of the at least one second cell frame and has a height of essentially 1% to 20%, preferably about 10%, of the thickness extension in the direction of the cell axis of a plate-shaped flat seal arranged closest to this at least one flat side along the cell axis.

It is advantageous that a flat gasket closest to the cell axis is plastically deformed in a targeted manner in order to increase the sealing effect between the cell frame and this plate-shaped element or to ensure it is particularly effective. Furthermore, operational sliding of a flat gasket, for example, relative to the adjacent cell frame is effectively prevented or greatly reduced by the circumferentially closed protuberance.

In particular, it may be advantageous if the at least one first cell frame and/or the at least one second cell frame has, on only one flat side or on both opposite flat sides, isolated and/or continuous surface sections with a higher surface roughness than the rest of the surface.

This has the advantageous effect of reducing or preventing operational sliding of the nearest plate-shaped element in these surface areas, for example induced by thermal stress, compared to a configuration without zones with increased surface roughness. Furthermore, when the cell frames and the anion exchange membrane are arranged in relation to each other or mounted along the cell axis, slipping of the individual parts is minimized, thus avoiding sources of error.

According to a further embodiment, it is conceivable that the partial channel intermediate areas between the partial channels have a higher surface roughness than the remaining surface of the at least one first cell frame and/or the at least one second cell frame on the flat side with the groove-like indentations.

As described, this advantageous configuration prevents a plate-shaped element, in particular a flat gasket, which is closest to the cell frame along the cell axis, and the cell frame from sliding against each other. This subsequently prevents a reduction in the cross-sectional area of the partial channels, which would occur due to sliding of the flat gasket.

In addition, it may be provided that the at least one first flow channel and/or the at least one second flow channel are formed by fluidically communicating elliptical apertures at least in the first and second cell frames and in the anion exchange membrane.

This has the positive effect that the elliptical flow channels have a reduced or enlarged inner surface in the vicinity of the outer and inner surface of the electrolytic cell when aligned accordingly, while at the same time the same flow throughput is ensured by to corresponding dimensioning of the elliptical flow channel cross-section. This ensures improved sealing of the elliptical flow channels along the cell axis of the electrolytic cell from the inner region or from the area outside the electrolytic cell.

It may be expedient if the at least one first cell frame and/or the at least one second cell frame is made of plastic. In particular, it may be expedient if the respective cell frame is produced by injection molding. It may be provided that the apertures for forming the flow channels are already provided in the injection molded part, i.e. in the respective cell frame produced by injection molding.

The advantage of this is that the unit costs for cell frames are lower compared to other manufacturing processes, such as the machining of blanks with the basic shape of a cell frame, due to the possible common part principle in combination with the injection molding process.

Furthermore, a method for producing at least one flow channel extending along the cell axis through at least two electrolytic cells arranged along the cell axis according to any of the preceding claims is provided. In the present method, at least the electrolytic cells are arranged in a row along the cell axis and held in relation to each other along the cell axis. Furthermore, the at least one flow channel is configured to be tapering or enlarging along the cell axis by means of a drilling device.

It is advantageous that the at least one flow channel is configured in such a way that the favorable effects already described are achieved. When arranging or stacking the individual elements of the electrolytic cells, rotational offsets of the individual elements relative to each other around the cell axis may occur. These rotational offsets would result in reductions in the flow channels through the electrolysis device or the at least two electrolytic cells along the cell axis. By producing the at least one flow channel in the assembled or joined state of the at least two electrolytic cells, these reductions in the size of the at least one flow channel are reduced or completely avoided, thereby enabling effective operation in accordance with the configuration of the supply of the half-cells of the electrolytic cells. Furthermore, the channel structure of the flow channels through the electrolytic cells may be individualized by this process with regard to the arrangement of the individual electrolytic cells along the cell axis. For example, depending on the required supply situation of an electrolytic cell, different channel structures and/or channel cross-sections of the flow channels may be realized by means of the method described, depending on their positioning along the cell axis within an electrolysis device.

For the purpose of better understanding of the invention, this will be elucidated in more detail by means of the figures below.

These show respectively in a simplified, schematic and exemplary representation:

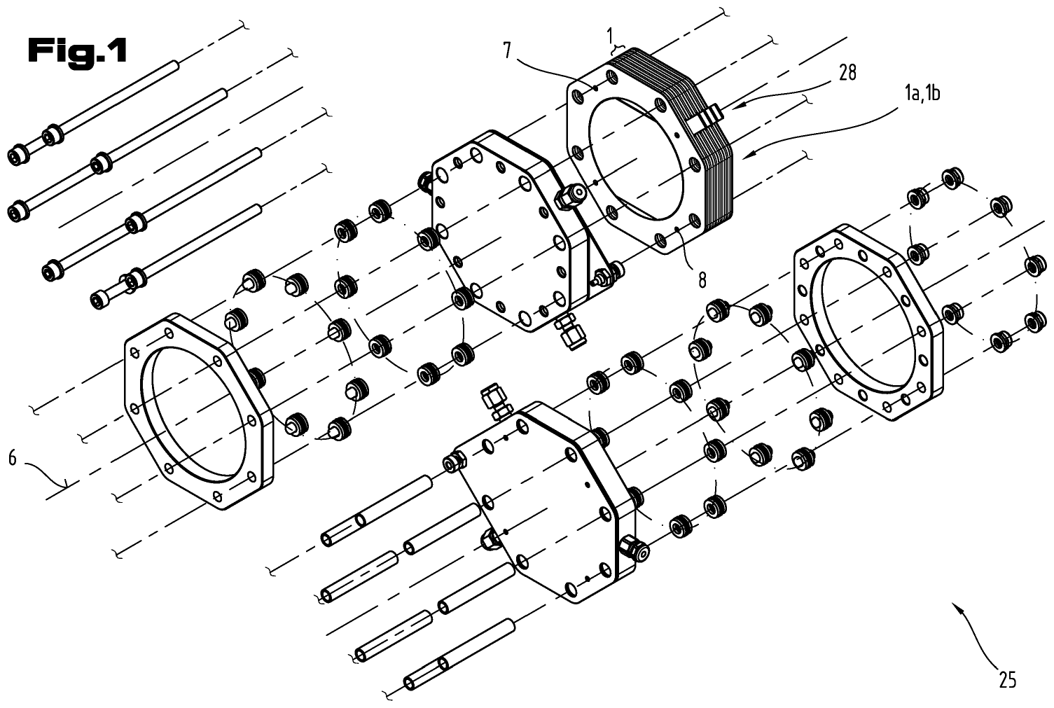

FIG. 1 an exploded view of a possible configuration of the electrolysis device;

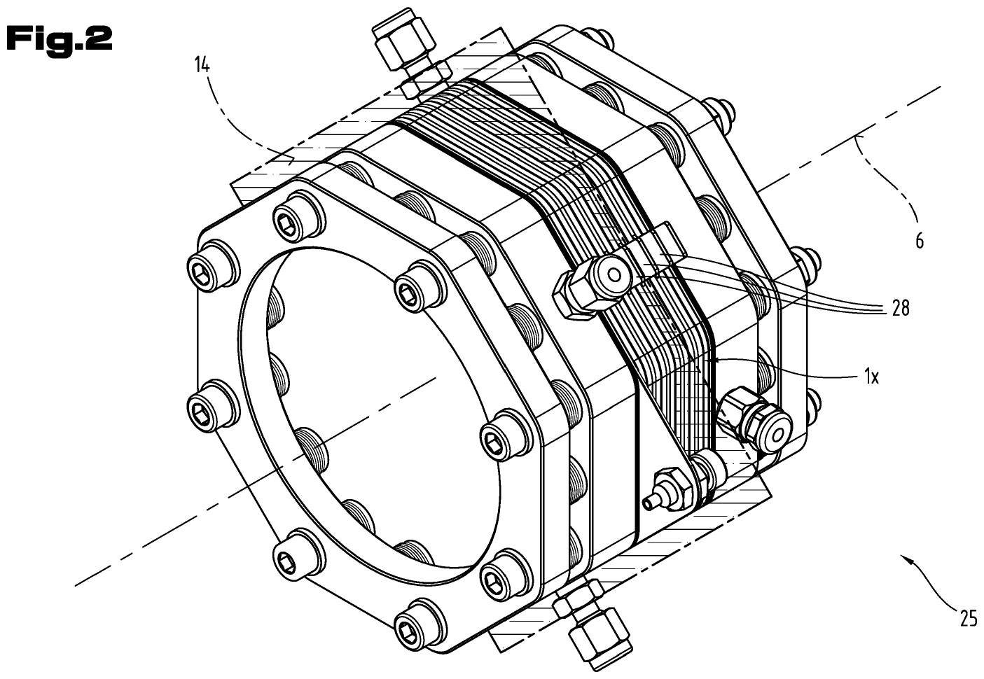

FIG. 2 a perspective view of the electrolysis device according to FIG. 1;

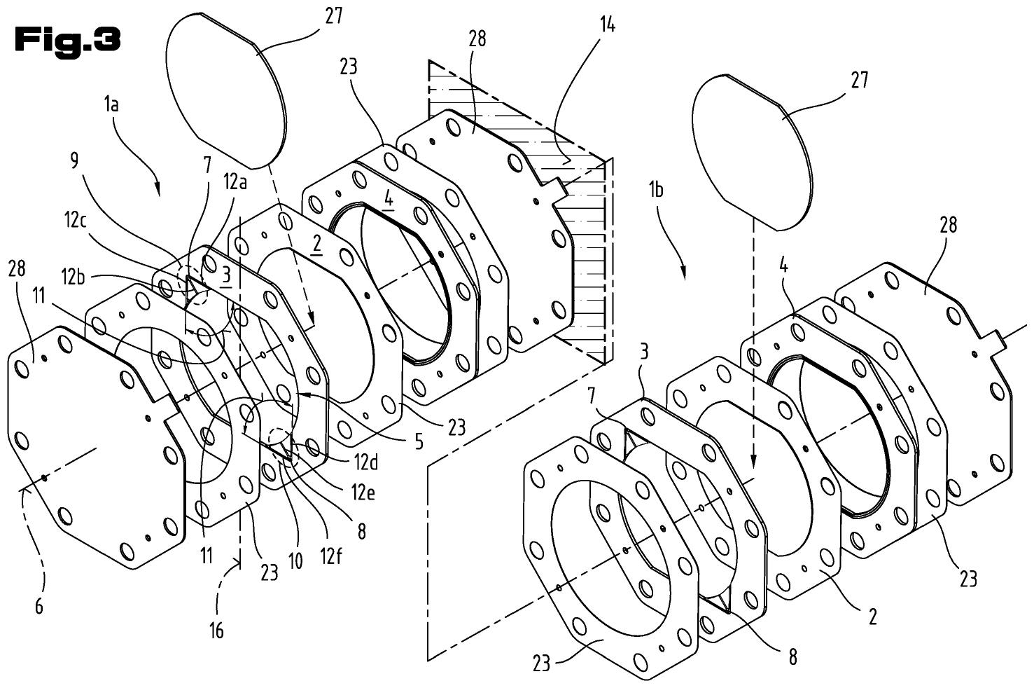

FIG. 3 a representation of two electrolytic cells arranged along the cell axis;

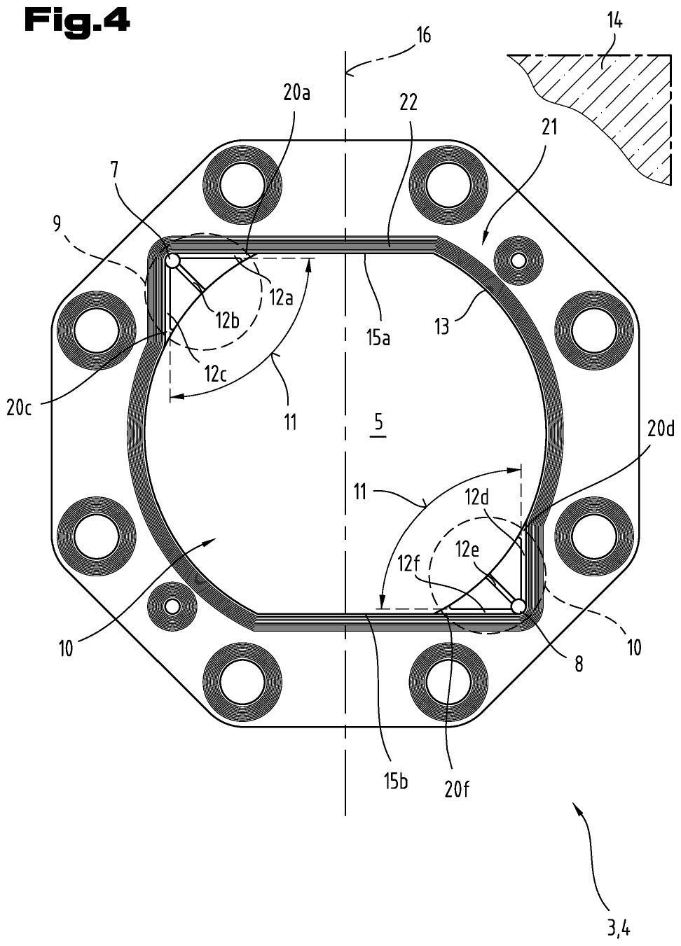

FIG. 4 a possible configuration of the cell frame in a simplified and schematic representation; and

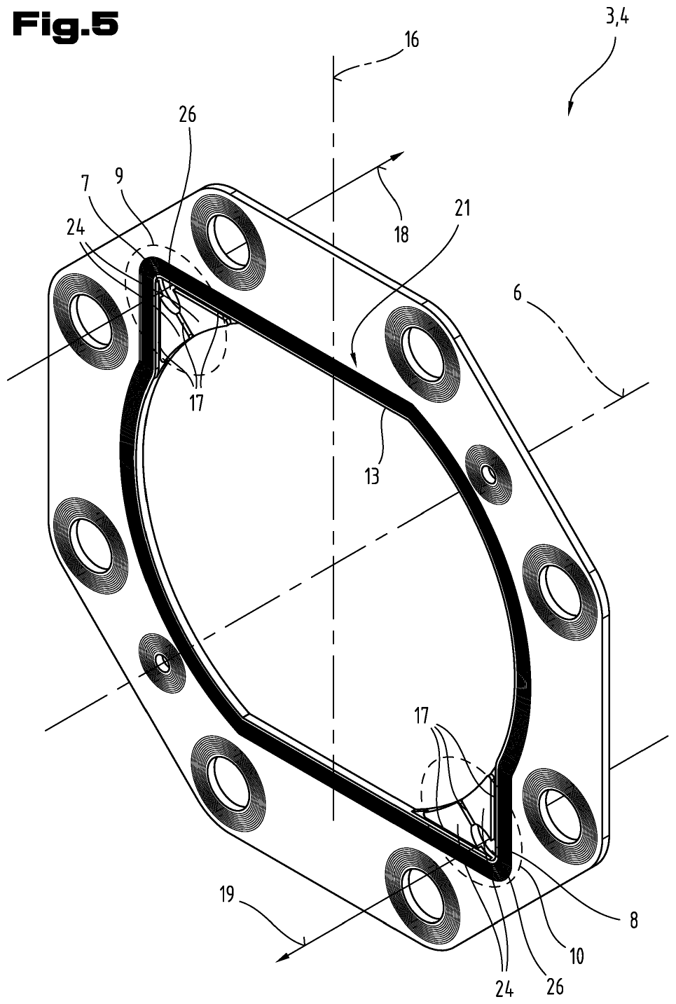

FIG. 5 a perspective view of a possible configuration of the cell frame.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

Furthermore, it should be noted that terms from the reference signs list are used in the description of the disclosure with and/or without a specific index in accordance with the reference signs list. If it is not necessary to differentiate between the terms in terms of their specific form, no indices are used. Conversely, for example, a partial channel 12a is differentiated from a partial channel 12b according to the respective description, wherein both are still partial channels 12.

FIG. 1 shows an exploded view of an embodiment of the electrolysis device 25. The electrolysis device 25 is provided with at least two electrolytic cells 1a, 1b arranged stacked or in series along the cell axis 6 as shown in FIG. 3. An electrolytic cell 1 may comprise at least one first cell frame 3 and at least one second cell frame 4, each arranged along the cell axis 6, as well as an anion exchange membrane 2. Furthermore, at least one flat gasket 23 and/or at least one bipolar plate may be arranged between two electrolytic cells 1 along the cell axis 6. Furthermore, the electrolytic cells 1a, 1b arranged along the cell axis 6 are provided with flow channels which are formed by apertures in the aforementioned flat or plate-like elements. In particular, the electrolytic cells 1a, 1b are provided with at least one first flow channel 7 and at least one second flow channel 8. The flow channels 7, 8 extend essentially parallel to the cell axis 6.

FIG. 2 shows the electrolysis device 25 according to FIG. 1 in an assembled state. Furthermore, the vertical frame plane 14 of the individual cell frames 4, 5 is shown when the electrolysis device 25 is in use. The first cell frame 3 may abut directly or indirectly on a first flat side of the anion exchange membrane 2 in a liquid-and gas-sealing manner and the second cell frame 4 may abut directly or indirectly on an opposite second flat side of the anion exchange membrane 2 in a liquid-and gas-sealing manner. The electrolysis device 25 may comprise a plurality of electrolytic cells 1x as shown.

In FIG. 3, two electrolytic cells 1 positioned along the cell axis 6 are shown in a highly simplified and schematic representation, wherein the same reference signs or component designations are used for identical parts as in the preceding FIGS. 1 and 2. FIG. 3 shows in a simplified schematic form a first electrolytic cell 1a and a second electrolytic cell 1b, which electrolytic cells 1 are arranged along the cell axis 6. Furthermore, FIG. 3 shows flat gaskets 23, which are arranged along the cell axis 6 before and after the electrolytic cell 1a and the electrolytic cell 1b. For a better understanding of the structure along the cell axis 6, FIG. 2 shows an electrolysis device 25 in an assembled state with several electrolytic cells 1x. As shown in FIG. 3, an electrolytic cell 1 stacked along the cell axis 6 comprises at least a first cell frame 3, an anion exchange membrane 2 and at least a second cell frame 4. According to the representation, the first cell frame 3 and the second cell frame 4 are mutually spaced along the cell axis 6, wherein the first cell frame 3 is arranged on a first flat side of the anion exchange membrane 2 and the second cell frame 4 is arranged on an opposite second flat side of the anion exchange membrane 2.

At least a first flow channel 7 and a second flow channel 8 are formed by axially aligned or at least partially aligned apertures in the electrolytic cells 1 and in the flat seals 23, as well as in any bipolar plates 28 that are present and may be seen in FIG. 2. The cell frames 3 and 4 each enclose an inner region 5, which is essentially formed as a central aperture in these essentially plate-shaped or flat elements. The at least one first flow channel 7 and the at least one second flow channel 8 are spaced apart from the cell axis 6 in the radial direction and are positioned opposite one another in relation to the cell axis 6.

Furthermore, at least one outflow channel structure 9 is provided, which is fluidically coupled to the first flow channel 7 and to the inner region 5. In addition, an inflow channel structure 10 is provided, which is fluidically coupled to the second flow channel 8 and to the inner region 5 of the respective cell frame 3, 4. The outflow channel structure 9 and/or the inflow channel structure 10 each comprise at least two partial channels 12a, 12c, and/or 12d, 12f, which partial channels 12 open directly into the first flow channel 7 and/or emerge directly from the second flow channel 8, each of the partial channels 12 being fluidically coupled to the inner region 5. The inflow channel structure 10 and/or the outflow channel structure 9 may, as shown by way of example, be formed by distributing or fan-shaped partial channels on or in the cell frames 3, 4. Accordingly, essentially triangularly delimited orifice sections are created starting from the second flow channel 8 in the direction of the inner regions 5 of the cell frames 3, 4 and essentially triangular merging zones are created starting from the inner regions 5 of the cell frames 3, 4 in the direction of the first flow channel 7.

Furthermore, it is indicated in schematic form in FIG. 3 that the at least one first cell frame 3 and the at least one second cell frame 4 are structurally identical and may be arranged rotated by 180° about the vertical axis 16. Subsequently, a conceivable embodiment may be that the at least one first cell frame 3 and the at least one second cell frame 4 are arranged opposite the anion exchange membrane 2 in such a way that the respective flat side of the cell frames 3 or 4 without partial channels 12 is arranged closest to the anion exchange membrane 2. It may be provided that the respective flat side of the cell frame 3 or 4, on which no partial channels 12 are formed, is coupled to the anion exchange membrane 2 in a dimensionally stable manner by bonding, welding and/or pressing. Thus, the coupling of at least one cell frame 3 or 4 to the anion exchange membrane 2 is gas-and liquid-tight or essentially technically tight. The typically groove-shaped partial channels 12 are thus formed on or in the flat side of the first and second cell frame 3, 4 facing away from the anion exchange membrane 2. Thus, an assembly or an electrolytic cell 1 may be formed from at least a first cell frame 3, a second cell frame 4 and at least one anion exchange membrane 2. The respective inner region 5 of a cell frame 3 or 4 thus forms a half-cell on each side of the anion exchange membrane 2. The electrolysis process is carried out in an electrolytic cell 1, in each case involving an anode half-cell and a cathode half-cell, which are fluidically separated by means of the anion exchange membrane 2.

In FIG. 3 it is schematically indicated that several electrolytic cells 1a or 1b may be arranged along the cell axis 6 and thus an electrolysis device 25 or a stack is formed, which electrolysis device 25 is shown in FIGS. 1 and 2. For example, in such a series of electrolytic cells 1x, it may be provided that the cross-section of at least one flow channel 7 or 8, which is formed by serially successive apertures in the individual essentially plate-shaped or flat components of the electrolytic cell 1, is configured to be increasingly tapering or increasingly enlarging along the cell axis 6. In this way, an advantageous flow state of the operating media for the serially arranged electrolytic cells 1a or 1b may be created across the individual electrolytic cells 1x as described above. Furthermore, FIG. 3 shows the conceivable arrangement of flat gaskets 23 between individual electrolytic cells 1. It may be provided that a flat gasket 23 is disposed before and after each electrolytic cell. Bipolar plates 28 may also be provided between electrolytic cells 1 in order to ensure the power supply to the membrane electrode unit 27 and thus the electrolysis process. A membrane electrode unit 27 is formed from at least one electrode and/or a diffusion or transport layer and associated with the respective inner region 5 of a cell frame 3 or 4, i.e. the respective half-cells of an electrolytic cell 1. The electrode and/or the associated diffusion layer is at least electrically conductively coupled to the surface of the anion exchange membrane 2 delimiting the respective inner region 5 of the electrolytic cell 1.

FIG. 4 shows a further and possibly independent embodiment of the cell frame 3 or cell frame 4 in a simplified and schematic representation, again using the same reference signs or component designations for the same parts as in the preceding FIGS. 1-3. The cell frame 3 or 4 may be configured in such a way that the outflow channel structure 9 and/or the inflow channel structure 10 comprise at least two partial channels 12a, 12c or 12d, 12f extending at an angle 11 to one another, which partial channels 12 open directly into the first flow channel 7 and/or emerge directly from the second flow channel 8. The partial channels 12 are fluidically coupled to the inner region 5, i.e. they are in flow connection with the inner region 5. The partial channels 12 of the outflow channel structure 9 and the inflow channel structure 10 may be formed on a flat side of the respective cell frame 3 or 4 by respective groove-like indentations 17 or embossings in the cell frame 3 or 4. It is useful if channel-like indentations 17 are formed in these flat sides, i.e. indentations that are rounded with respect to their cross-section, in which the operating media of the electrolytic cell 25 (FIG. 2) can be guided.

Furthermore, it may be provided that a cell frame 3 or 4 has an inner limiting edge 13 in each case, which inner limiting edge 13 may in turn have a lower and/or an upper straight section 15a or 15b in a lower region related to a vertical plane 14 (FIG. 2) and/or in an upper region. In this case, it may be provided that in the lower straight section 15b at least one partial channel 12f of the inflow channel structure 10 extends parallel or substantially parallel or in alignment with the lower straight section. Similarly, it may be provided that in the upper straight section 15a at least one partial channel 12a of the outflow channel structure 9 extends parallel or substantially parallel or in alignment with the upper straight section 15a. In the embodiment shown, it may be seen that at least the partial channel 12a of the outflow channel structure 9 is thus fluidically coupled to the inner region 5 of a cell frame 3 or 4 with respect to the vertically extending frame plane 14 at an uppermost section of the inner limiting edge 13 with the inner region 5. As shown in FIG. 4, it is conceivable for the inner limiting edge 13 of a cell frame 3 or 4 to be formed according to a circular shape or to have a circular shape at least in sections. Furthermore, an embodiment is conceivable in which the inner limiting edge 13 of a cell frame 3 or 4 is formed according to an elliptical shape, with the ellipse major axis or the ellipse minor axis extending parallel or substantially parallel to the vertical axis 16.

A conceivable configuration of the cell frame 3 or 4 is that the partial channels 12 are configured to be enlarging, in particular trumpet-shaped, in the direction from the respective flow channel 7 or 8 to the inner region 5 of the respective cell frame 3 or 4. This conceivable configuration shows the advantages already described. It may also be provided that the at least two partial channels 12a, 12c or 12d, 12f of the respective outflow channel structure 9 and/or inflow channel structure 10 extend at an angle 11 in the range between 27.5° and 135° to one another. In particular, the two partial channels 12a, 12c or 12d, 12f may be arranged at an angle 11 of 90°. At least a third partial channel 12b or 12e may be arranged between the at least two partial channels 12a, 12c or 12d, 12f of the respective outflow channel structure 9 and/or the inflow channel structure 10.

An extended embodiment in which the partial channels 12 of the outflow channel structure 9 and/or the inflow channel structure 10 each have different cross-sectional shapes and/or surface cross-sections may be particularly advantageous. For example, the partial channel 12b may have a larger surface or flow cross-section than the partial channel 12a in order to favor the discharge of gas bubbles dissolved in the operating medium during operation of the electrolytic cell. At the same time, this effect is intensified by a backpressure effect of the two-phase mixture in the interior or inner region 5 of the respective cell frame 3 or 4 induced by the smaller partial channel 12a in relation to the cross-sectional area, as a result of which the discharge of the gas bubbles in the partial channel 12b, which is located in the uppermost area of the inner region 5 in relation to the vertically extending frame plane 14, may be improved.

FIG. 4 shows a further and possibly independent embodiment of the cell frame 3 or cell frame 4 in a perspective view, again using the same reference signs or component designations for the same parts as in the preceding views. In this embodiment, it may be seen that at least one circumferentially closed protuberance 21 is formed, which extends along the inner limiting edge 13 of the cell frame 3 or 4 and thereby encloses the outflow channel structure 9 and/or the inflow channel structure 10. This at least one circumferentially closed protuberance 21 may form a sealing element 22. This protuberance 21 may be formed as a bead-like elevation integral with the respective cell frame 3 or 4, wherein the protuberance 21 has essentially 1% to 20%, preferably 10%, of the thickness extension in the direction of the cell axis 6 of a nearest element arranged along the cell axis 6. As shown in FIGS. 1 to 3, an element arranged closest along the cell axis 6 may be a flat gasket 23. Thus, the protuberance 21 may preferably have a protrusion of 10% relative to the base or main surface of the flat side of a cell frame 3 or 4 in relation to the thickness extension of the flat seal 23 along the cell axis 6.

A conceivable configuration of the embodiment shown is that a cell frame 3 or 4 has isolated and/or continuous, superficially roughened zones on at least one flat side or on both opposite flat sides. The surface roughness of these zones may be increased compared to the surface roughness of the remaining flat side. These superficially roughened zones may be arranged isolated. In particular, it may be expedient if the partial channel intermediate regions 24 have an increased surface roughness compared to the remaining surface of the same flat side of a cell frame 3 or 4. Similarly, the superficially roughened zones may be provided on the flat side of the cell frame 3 or 4 opposite the outflow channel structure 9 and inflow channel structure 10 in order to favor the arrangement or positioning and/or assembly of the anion exchange membrane 2 in conjunction with the cell frames 3, 4.

It may also be provided that the flow channels 7 or 8 are formed by elliptical apertures 26 in the elements of the electrolytic cell 1x (FIG. 2) among others. The elliptical apertures 26 may be provided in all elements of the electrolytic cells 1x, such as in the cell frames 3 or 4, the anion exchange membranes 2, flat gaskets 23 and/or bipolar plates 28.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### REFERENCE SIGNS LIST

1 electrolytic cell
2 anion exchange membrane
3 first cell frame
4 second cell frame
5 inner region
6 cell axis
7 first flow channel
8 second flow channel
9 outflow channel structure
10 inflow channel structure
11 angle
12 partial channel
13 inner limiting edge
14 vertical frame plane
15 straight section
16 vertical axis
17 groove-like indentations
18 first flow channel direction
19 second flow channel direction
20 widening
21 protuberance
22 sealing element
23 flat gasket
24 partial channel intermediate area
25 electrolysis device
26 elliptical apertures
27 membrane electrode unit
28 bipolar plate

1. Electrolytic cell for producing gaseous hydrogen, comprising:
at least one anion exchange membrane,
at least one first cell frame and at least one second cell frame, wherein each delimits an inner region which is provided for receiving an electrolyte and/or a membrane electrode unit, and which first and second cell frames are spaced apart from one another in the direction of a cell axis with respect to their respective defined frame planes, wherein the first cell frame abuts on a first flat side of the anion exchange membrane directly or indirectly in a liquid-and gas-sealing manner and the second cell frame abuts on an opposite second flat side of the anion exchange membrane directly or indirectly in a liquid-and gas-sealing manner,
at least one first flow channel and at least one second flow channel, which are each formed by fluidically communicating apertures in the first and second cell frame and in the anion exchange membrane and whose main direction ex-tends parallel or substantially parallel to the cell axis,
wherein the first and second cell frame each comprise;
at least one outflow channel structure, which is fluidically coupled to the first flow channel and to the inner region of the respective cell frame, and
at least one inflow channel structure, which is fluidically coupled to the second flow channel and to the inner region of the respective cell frame,
wherein the at least one first flow channel and the at least one second flow channel are spaced apart in the radial direction with respect to the cell axis and are positioned opposite one another with respect to the cell axis, and
wherein the outflow channel structure and/or the inflow channel structure each comprises at least two partial channels extending at an angle to one another, which partial channels open directly into the at least one first flow channel and/or emerge directly from the at least one second flow channel, and in that each of the partial channels is fluidically connected to the inner region of the respective cell frame.

2. The electrolytic cell according to claim 1, wherein the first and/or second cell frame is provided with an inner limiting edge which defines a limiting section of the inner region, and which inner limiting edge has, in relation to a vertically extending frame plane of the first and/or second cell frame an upper and/or a lower straight section in the upper region and/or in the lower region, wherein in the lower straight section at least one partial channel of the inflow channel structure extends parallel to or in alignment with the lower straight section and wherein in the upper straight section at least one partial channel of the outflow channel structure extends parallel to or in alignment with the upper straight section.

3. The electrolytic cell according to claim 1, wherein at least one partial channel of the outflow channel structure is fluidically coupled to the inner region of the first and/or second cell frame with respect to the vertically extending frame plane at an uppermost section of the inner limiting edge with the inner region.

4. The electrolytic cell according to claim 1, wherein the at least one first cell frame and the at least one second cell frame are structurally and geometrically identical and are arranged turned through 180° with respect to a vertical axis extending in the vertically extending frame plane.

5. The electrolytic cell according to claim 1, wherein the at least one first cell frame and the at least one second cell frame each have an out-flow channel structure and an inflow channel structure, and in that the respective out-flow channel structure and the respective inflow channel structure of the respective cell frame are formed by respective groove-like indentations or embossings in only one of the two flat sides of the respective cell frame.

6. The electrolytic cell according to claim 5, wherein the at least one first cell frame and the at least one second cell frame are arranged opposite the anion exchange membrane in such a way that the respective flat side of the cell frames with-out groove-like indentations or embossings is associated closest to the anion-exchanger membrane.

7. The electrolytic cell according to claim 6, wherein the anion exchange membrane is connected in a liquid-tight and gas-tight manner to the nearest associated flat side of the at least one first cell frame and/or the at least one second cell frame by bonding, welding and/or pressing.

8. The electrolytic cell according to claim 1, wherein the inner limiting edge of the first and/or second cell frame has a circular arc shape or an elliptical shape in sections and, in the case of an elliptical shape, its main elliptical axis or its secondary elliptical axis is oriented parallel or essentially parallel to the vertical axis.

9. The electrolytic cell according to claim 1, wherein the cross-section of the at least one first flow channel and/or of the at least one second flow channel of the electrolytic cell is configured to be increasingly tapering or increasingly enlarging along the cell axis.

10. The electrolytic cell according to claim 9, wherein the at least one first flow channel is configured to be increasingly enlarging in a first flow channel direction along the cell axis and in that the at least one second flow channel is configured to be increasingly tapering in a second flow channel direction opposite to the first flow channel direction.

11. The electrolytic cell according to claim 1, wherein the flow cross-section of at least one partial channel of the outflow channel structure and/or of the inflow channel structure is provided with a widening starting from the respective flow channel in the direction of the inner region, which widening is configured in particular to be trumpet-shaped.

12. The electrolytic cell according to claim 1, wherein the at least two partial channels of the outflow channel structure and/or the at least two partial channels of the inflow channel structure extend at an angle in the range between 27.5° and 135°, in particular at an angle of 90°, to one an-other and that at least a third partial channel is arranged between the at least two partial channels of the outflow channel structure and/or at least a third partial channel is arranged between the at least two partial channels of the inflow channel structure.

13. The electrolytic cell according to claim 1, wherein along the inner limiting edge of the at least one first cell frame and/or of the at least one second cell frame at least one protuberance enclosing the outflow channel structure and/or the inflow channel structure and circumferentially closed is formed opposite the base surface of the respective cell frame, which at least one protuberance is provided as a sealing element.

14. The electrolytic cell according to claim 13, wherein the at least one circumferentially closed protuberance is formed at least on one flat side of the at least one first cell frame and/or of the at least one second cell frame and has a height of essentially 1% to 20%, preferably approximately 10%, of the thickness extension in the direction of the cell axis of a plate-shaped flat gasket arranged closest to this at least one flat side along the cell axis.

15. The electrolytic cell according to claim 1, wherein the at least one first cell frame and/or the at least one second cell frame has on only one flat side or on both opposite flat sides, isolated and/or continuous surface sections with a higher surface roughness than the rest of the surface.

16. The electrolytic cell according to claim 1, wherein partial channel intermediate regions between the partial channels have a higher surface roughness than the remaining surface of the at least one first cell frame and/or of the at least one second cell frame on the flat side with the groove-like indentations.

17. The electrolytic cell according to claim 1, wherein the at least one first flow channel and/or the at least one second flow channel are formed by fluidically communicating elliptical apertures at least in the first and second cell frames and in the anion exchange membrane.

18. The electrolytic cell according to claim 1, wherein the at least one first cell frame and/or the at least one second cell frame are made of plastic and in particular may be produced in one piece or integrally by injection molding.

19. The electrolytic cell according to claim 18, wherein the apertures for forming the at least one first flow channel and/or the at least one second flow channel and/or the partial channels and/or the circumferentially closed protuberance in the at least one first cell frame and/or in the at least one second cell frame are/may be produced in one piece or integrally.

20. A method for producing at least one flow channel extending along the cell axis by at least two electrolytic cells arranged along the cell axis according to any of the preceding claims, wherein,
at least the electrolysis cells are arranged in a row along the cell axis and are held relative to one another along the cell axis, and
and the at least one flow channel is configured to be tapering or enlarging along the cell axis by means of use of a drilling device.
